(19) United States
(12) Patent Application Publication
(10) Pub. No.: US 2010/0208929 A1
(43) Pub. Date: Aug. 19, 2010

(54) MICROPHONE HAVING REAR PHASE REJECTION COLLECTION TUBE

(76) Inventor: Robert Heil, Belleville, IL (US)

Correspondence Address: BRYAN CAVE LLP, 211 NORTH BROADWAY, SUITE 3600, ST. LOUIS, MO, 63102-2750, US

(21) Appl. No.: 12/370,740

(22) Filed: Feb. 13, 2009

(51) Int. Cl. H04R 11/04

(52) U.S. Cl. 381/355

(57) ABSTRACT

A microphone includes an annular gap between the inner cylindrical housing and the outer tubular shell such that the undesired acoustical signals entering the microphone from the side and rear flow into and through the annular gap. The signals are ported through a phase reversal entrance circumferentially surrounding a magnet assembly and impact the diaphragm such that the undesired acoustical signals entering the front of the microphone are substantially cancelled out by undesired acoustical signals originating from the side and rear.

### FIELD OF THE INVENTION

This invention relates generally to vocal microphones and, in particular, to microphones capable of rejecting undesired background noise.

### BACKGROUND OF THE INVENTION

Although certain cardioid or unidirectional microphones are designed to pick up sounds emanating primarily from in front of the microphone, it is fairly common that such microphones will also pick up some sounds originating from behind or to the side of the microphone. In order to reduce the amplification of these unwanted sounds, microphones may be designed to purposefully allow these sounds to enter the microphone from the rear or back of the microphone for processing by the dynamic element. Typically there is a time delay between the time the unwanted sounds enter the rear of the microphone and when the sounds enter the front of the microphone. This time delay is beneficial because there is a phase shift in the sound waves entering the front and rear of the microphone. Because of the phase shift, the sound is effectively cancelled out and not processed or amplified by the microphone.

Conventional microphones designed to removed unwanted sounds originating from the rear or side of the microphone, or reflections of desired sounds, are typically designed with a small number of ports that allow entry of some of these unwanted sounds into the rear of the microphone so that they may cancel out any such sounds entering the front of the microphone. However, due to the limited number of ports and the overall design of these conventional microphones, not all unwanted sounds in each audio frequency band are removed. Consequently, these conventional microphones tend to process and amplify some unwanted sounds.

A need exists, therefore, for an improved microphone that substantially reduces the processing and amplification of unwanted sounds. Preferably, the improved microphone would provide for an increase in front to rear signal ratio and improved side and rear cancellation.

### SUMMARY OF THE INVENTION

According to one aspect of the present invention, a microphone for processing and amplification of desired acoustical signals includes an inner cylindrical housing and an outer tubular shell enclosing the inner cylindrical housing. The shell has front apertures permitting entrance of both desired acoustical signals and undesired acoustical signals, the undesired acoustical signals entering the front apertures characterized as having an acoustical frequency and a first phase. The shell also includes side apertures permitting entrance of the undesired acoustical signals at a second phase such that the undesired acoustical signals entering the side apertures are out of phase with the undesired acoustical signals entering the front apertures. The microphone also includes an annular gap between the inner cylindrical housing and the outer tubular shell such that the undesired acoustical signals entering the side apertures flow into and through the annular gap.

Preferably, the microphone includes a phasing plug assembly mounted within the top end of the cylindrical housing that includes a ring retaining a diaphragm. The desired and undesired acoustical signals entering the front apertures pass to a top side of the diaphragm, causing it to vibrate. Preferably, a magnet assembly having a resonant cavity is arranged at least partially within the interior of the ring forming a phase reversal entrance between an outside surface of the magnet assembly and an interior surface of the ring. In use, the annular gap collects the undesired acoustical signals entering the side apertures and ducts the undesired acoustical signals through the phase reversal entrance to a bottom side of the diaphragm such that the undesired acoustical signals entering the front apertures are substantially cancelled out by the undesired acoustical signals entering the side apertures.

### BRIEF DESCRIPTION OF THE FIGURES

These and other features, aspects and advantages of the invention will become more fully apparent from the following detailed description, appended claims, and accompanying drawings, wherein the drawings illustrate features in accordance with an exemplary embodiment of the present invention, and wherein:

FIG. 1 is an illustration of the microphone of the present invention;

FIG. 2 is an illustration of the interior of the microphone with the outer tubular shell removed;

FIG. 3 is an exploded sectional view of the phasing plug assembly and magnet assembly of the present invention;

FIGS. 4, 5 and 6 are further views of the phasing plug and magnet assemblies; and

FIG. 7 is an illustration of acoustical signals funneling along the exterior of the inner cylindrical housing.

### DETAILED DESCRIPTION OF THE INVENTION

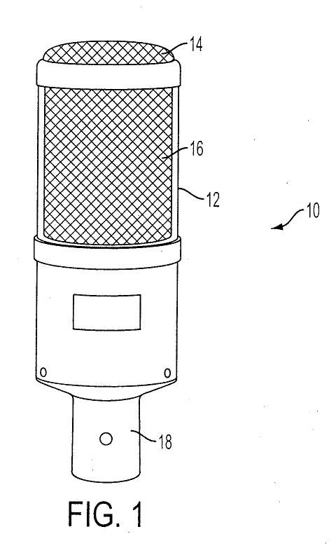

Referring to FIG. 1, the microphone 10 includes a hollow outer tubular shell 12 formed in a cylindrical shape. The shell 12 has front apertures 14 located on its top end and side apertures 16 substantially circumferentially surrounding the shell 12. The apertures 14 and 16 are designed to allow acoustical signals to flow into the interior of the tubular shell 12 for processing and possible amplification by the microphone 10. The apertures 14 and 16 may be formed from mesh screening, for example an inner and outer layer of mesh screening, with the outer layer having larger openings than the inner layer. The tubular shell 12 may be attached to a microphone base 18, which may act as a handle and typically houses the microphone cord.

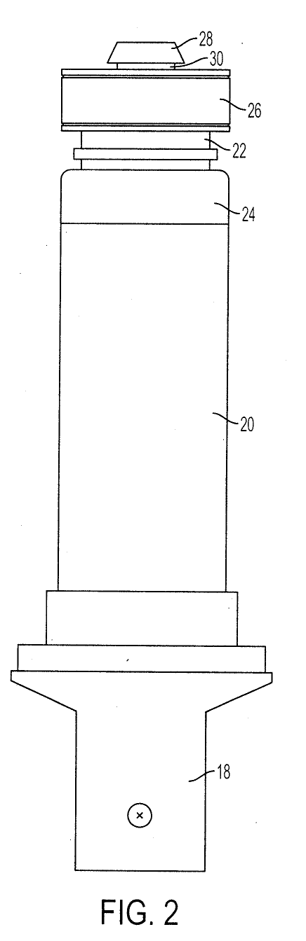

FIG. 2 illustrates the components of the microphone 10 contained within the tubular shell 12. The microphone 10 includes an inner cylindrical housing 20 having a microphone magnet assembly 22 directly or indirectly seated within its top end. The magnet assembly 22 (which as described below includes a housing plus magnets and coils) may be seated at least partially within a shock mount device 24, that is then inserted into the inner cylindrical housing 20. The shock mount device 24 reduces transmission of vibrations and handling noise into the microphone active elements. The shock mount device 24 is preferably fabricated from a visco-elastic polymer, preferably a thermoset, polyether-based polyurethane material such as Sorbothane brand polyurethane commercially available from Sorbothane, Inc. of Kent, Ohio. The shock mount device 24 is a generally hollow cylindrical element into the top end of which the magnet assembly 22 is seated.

The microphone 10 may also include a humbucking coil 28, for example, a 60 Hz humbucking coil, and a humbucking bobbin 30 designed to shield the components inside the magnetic assembly 22 from interference from electronic equipment such as computer monitors and/or noisy lighting fixtures and controls.

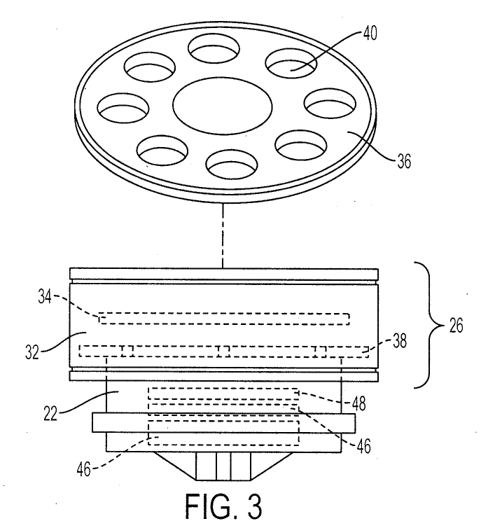

A phasing plug assembly 26 is mounted above and is in acoustical communication with the magnet assembly 22. As illustrated in FIG. 3, the phasing plug assembly 26 preferably includes an outer ring 32, the interior of which contains a diaphragm 34. The diaphragm may be retained within a partially sonically transparent plate structure that includes a upper plate 36 and a lower plate 38. The top plate 36 includes number of sound ports 40, which permit the passage of acoustical signals entering via the front apertures 14 to reach the diaphragm 34. Similarly, the lower plate 38 includes a number of sound ports 42, which permit acoustical signals entering the microphone via the side apertures 16 to reach the diaphragm 34 as discussed below.

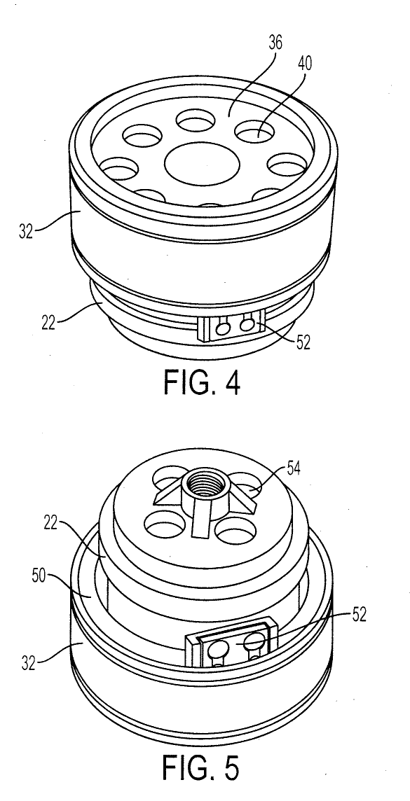

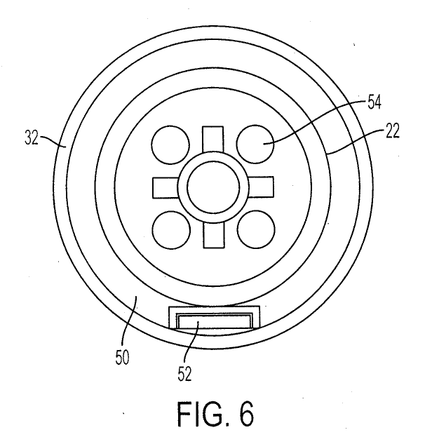

As shown in FIGS. 3-6, the upper portion of the magnet assembly 22 is partially contained within the interior of the ring 32 and includes a hollow resonant cavity that houses the magnets 46 and magnet loop 48. Thus, preferably, the diaphragm 34 overlies the hollow resonant cavity housing the magnet components. The magnetic components or circuit convert the vibrating diaphragm into an electrical signal. The magnet assembly 22 is preferably includes a plastic circular casing having an outer diameter less than the inner diameter of the ring 32, thus forming a phase reversal entrance 50 between the outside surface of the magnet assembly 22 and the interior of the ring 32 that extends substantially the entire circumference of the inner surface of the ring 32. As shown in FIGS. 4-6, the magnet assembly 22 may include holes 54 formed in its lower end to allow the passage of wiring and electrical connection 52 to couple the magnetic components of the magnet assembly 22 to the microphone cord.

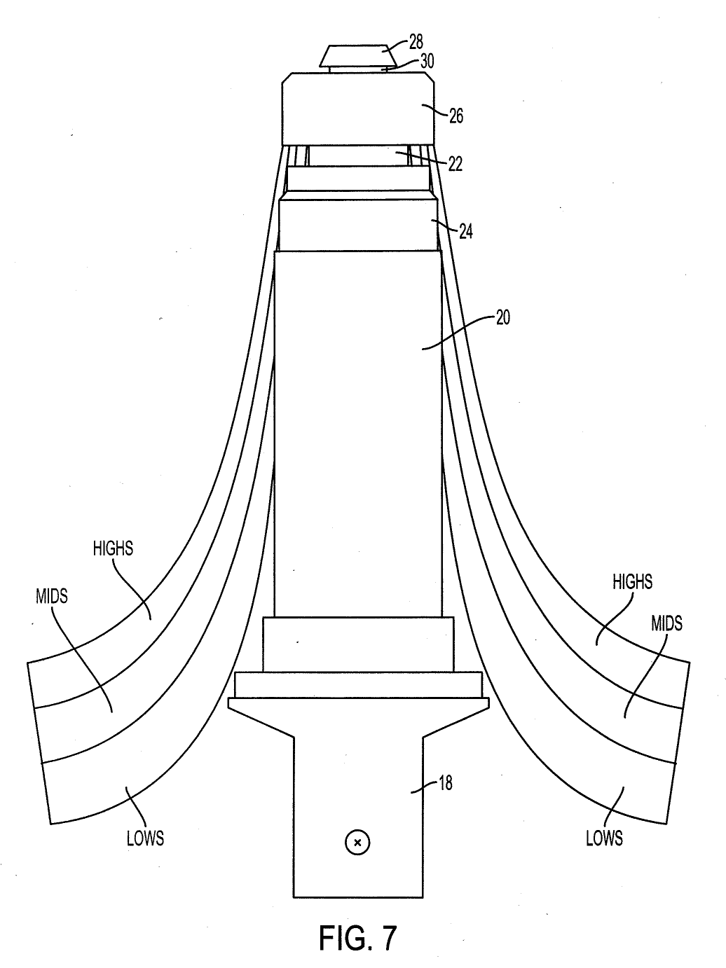

FIG. 7 is an illustration of acoustical signals, represented by high, mid and low frequency signals, funneling along the exterior of the inner cylindrical housing 20. As illustrated in the figure, the undesired acoustical signals entering the side apertures 16 are funneled along the annular gap and into the phase reversal entrance 50 to a bottom side of the diaphragm 34.

In use, unwanted sounds originating from the side or rear of the microphone 10 enter the side apertures 16 and pass through an annular gap located between the inner cylindrical housing 20 and the outer tubular shell 12 and into the phase reversal entrance 50. The phase reversal entrance 50 is in acoustical communication with the bottom of the diaphragm 34 via the sound ports 42 in the lower plate 38 so that the unwanted sound waves impact the diaphragm 34. These undesired sounds entering the side apertures 16 are out of phase with the same sound frequencies entering into the front apertures 14 of the microphone 10, therefore cancelling one another out. Thus, the front apertures 14 provide an entrance for undesired acoustical signals characterized as having an acoustical frequency and a first phase, and the side apertures 16 permit entrance of the undesired acoustical signals at a second phase such that the undesired acoustical signals entering the side apertures 16 are out of phase with the undesired acoustical signals entering the front apertures 14. The undesired acoustical signals entering the side apertures 16 flow into the annular gap between the inner cylindrical housing 20 and the outer tubular shell 12. The phase reversal entrance 50 is uniquely designed and situated to selectively regulate the entry of sound pressure wavefronts channeled up through the annular gap between the outer tubular shell 12 and the inner cylindrical housing 20.

Although certain illustrative embodiments and methods have been disclosed herein, it will be apparent from the foregoing disclosure to those skilled in the art that variations and modifications of such embodiments and methods may be made without departing from the spirit and scope of the invention. Accordingly, it is intended that the invention should be limited only to extent required by the appended claims and the rules and principals of applicable law.

1. A microphone for processing and amplification of desired acoustical signals comprising:
an inner cylindrical housing having a top end;
an outer tubular shell enclosing the inner cylindrical housing, the shell having front apertures permitting entrance of desired acoustical signals and undesired acoustical signals, the undesired acoustical signals entering the front apertures characterized as having an acoustical frequency and a first phase, and side apertures permitting entrance of the undesired acoustical signals at a second phase such that the undesired acoustical signals entering the side apertures are out of phase with the undesired acoustical signals entering the front apertures, and wherein the undesired acoustical signals entering the side apertures flow into an annular gap between the inner cylindrical housing and the outer tubular shell;
a phasing plug assembly mounted within the top end of the cylindrical housing comprising a ring retaining a diaphragm, the ring having a top end though which the desired and undesired acoustical signals entering the front apertures pass to a top side of the diaphragm, the desired acoustical signals causing the diaphragm to vibrate; and
a magnet assembly having a resonant cavity arranged at least partially within the interior of the ring forming a phase reversal entrance between an outside surface of the magnet assembly and the interior of the ring;
wherein the annular gap collects the undesired acoustical signals entering the side apertures and ducts the undesired acoustical signals through the phase reversal entrance to a bottom side of the diaphragm such that the undesired acoustical signals entering the front apertures are substantially cancelled out by the undesired acoustical signals entering the side apertures.

2. The microphone of claim 1 wherein the diaphragm overlies the resonance cavity.

3. The microphone of claim 1 wherein the diaphragm is further retained within front and back sonically transparent plates.

4. The microphone of claim 3 wherein the front plate comprises a plurality of sound ports.

5. The microphone of claim 1 wherein the magnet assembly houses a magnetic circuit to convert the vibrating diaphragm into an electrical signal.

6. The microphone of claim 1 further comprising a cylindrical shock mount device having a lower portion positioned within the top end of the cylindrical housing and an upper portion extending outwardly beyond the top end of the cylindrical housing, wherein the phasing plug assembly is partially positioned within the upper portion of the shock mount device.
